(19) United States
(12) Patent Application Publication
(10) Pub. No.: US 2019/0126190 A1
(43) Pub. Date: May 2, 2019

(54) MULTI-STAGE ADSORPTIVE GAS SEPARATION PROCESS AND SYSTEM

(71) Applicant: INVENTYS THERMAL TECHNOLOGIES INC., Burnaby (CA)

(72) Inventors: Andre BOULET, Bowen Island (CA); Soheil KHIAVI, North Vancouver (CA)

(21) Appl. No.: 16/089,722

(22) PCT Filed: Mar. 31, 2017
(86) PCT No.: PCT/CA2017/050394

§ 371 Date: Sep. 28, 2018

Related U.S. Application Data
(60) Provisional application No. 62/316,433, filed on Mar. 31, 2016.

(51) Int. Cl. B01D 53/04

(52) U.S. Cl. CPC B01D 53/0462; B01D 2257/504; B01D 2259/402; B01D 2259/40081; B01D 2259/40056; B01D 2259/40079

(57) ABSTRACT

A multi-stage adsorptive gas separation process and system for separating at least a first component from a multi-component fluid mixture employs at least a first and second adsorption stage, for reducing overall steam and energy consumption for regeneration of an adsorbent material. In the adsorptive gas separation system, a first-stage adsorptive gas separation process and separator, and a second-stage adsorptive gas separation process and separator, each employ one regenerating stream, where the regenerating streams have different regeneration mediums.

### TECHNICAL FIELD

The present invention relates generally to methods for adsorptive gas separation of a multi-component fluid mixture and systems therefore. More particularly, the present invention relates to methods for adsorptive gas separation of carbon dioxide from a combustion gas stream and systems incorporating the same.

### BACKGROUND

Temperature swing adsorptive gas separation processes and systems are known in the art for use in adsorptive gas separation of multi-component fluid mixtures. One type of industrial process where gas separation may be desirable includes combustion processes, for example, where an oxidant and a carbon-containing fuel are combusted generating at least heat and a combustion gas stream. The separation of at least one component from the combustion gas stream may be desirable, including for example, post-combustion gas separation of carbon dioxide, but may typically face several challenges including, for example, the volume of gas to be treated for separation may be large, the combustion gas stream may contain dilute amounts of the target component desired to be separated, and/or the combustion gas stream may be supplied at a low pressure.

A conventional temperature swing adsorptive gas separation process may typically employ two fundamental steps, an adsorption step and a regeneration step. During an adsorption step, a feed stream such as a multi-component fluid mixture may typically be admitted into an adsorptive separation system and contactor comprising an adsorbent material, where the adsorbent material may adsorb a component of the feed stream, separating the adsorbed component from the remaining components of the feed stream. During a subsequent regeneration step, a fluid stream, for example, a heated fluid stream, may typically be admitted into the adsorptive separation system and contactor to increase the temperature of the adsorbent material, causing the adsorbed components to release from the adsorbent material, and allow for cyclic reuse of the adsorbent material. An optional cooling or conditioning step may be employed to decrease the temperature of the adsorbent material after the desorption step, to assist in restoring the adsorptive capacity of the adsorbent material prior to a subsequent adsorbing step. A coolant or conditioning stream may commonly be admitted into the adsorptive separation system and contactor to decrease the temperature of the adsorbent material. The adsorption, regeneration and conditioning steps may then typically be sequentially repeated.

Inefficiencies in conventional temperature swing adsorptive gas separation processes and systems have typically led to undesirably inefficient integration of such temperature swing adsorptive gas separation systems into fossil fuel combustion processes. In order for wide industry acceptance, temperature swing adsorptive gas separation processes and systems must be able to meet or exceed desired thresholds including, for example, a recovery threshold of the target component, a purity threshold for a product stream comprising the target component, and an operating cost threshold. With conventional temperature swing adsorptive gas separation processes and system typical desired recovery and purity thresholds may be approached through employing large quantities of heated regeneration fluids, such as steam, however such approaches typically result in making the operating cost prohibitive and conventional techniques economically unattractive. Accordingly, an adsorptive gas separation process and system which is capable of meeting or exceeding industry desired recovery and purity thresholds while reducing steam consumption and operating costs is desired.

### SUMMARY

In various embodiments according to the present disclosure a multi-stage adsorptive gas separation process for separating at least a first component from a multi-component fluid mixture is provided. In one such embodiment, the process comprises the steps of:

admitting the multi-component fluid mixture as at least a portion of a feed stream into a first-stage adsorptive gas separator, adsorbing at least a portion of the first component of the feed stream of the first-stage adsorptive gas separator on at least one adsorbent material in a contactor in the first-stage adsorptive gas separator, recovering a first product stream from the first-stage adsorptive gas separator;

admitting a first regeneration stream into the first-stage adsorptive gas separator, desorbing at least a portion of the first component adsorbed on the at least one adsorbent material in the contactor in the first-stage adsorptive gas separator, recovering a second product stream from the first-stage adsorptive gas separator enriched in the first component relative to the multi-component fluid mixture,

admitting the second product stream from the first-stage adsorptive gas separator as a feed stream into a second-stage adsorptive gas separator, adsorbing at least one of the first component or a second component of the feed stream of the second-stage adsorptive gas separator on at least one adsorbent material in a contactor in the second-stage adsorptive gas separator, recovering a first product stream from the first-stage adsorptive gas separator, and

admitting a first regeneration stream into the second-stage adsorptive gas separator, desorbing at least a portion of one of the first component or the second component adsorbed on the at least one adsorbent material in the contactor in the second-stage adsorptive gas separator, recovering a second product stream from the first-stage adsorptive gas separator.

In various further embodiments according to the disclosure, a multi-stage adsorptive gas separation system for separating at least a first component from a multi-component fluid stream is provided. In one such embodiment, the system comprises:

a first-stage adsorptive gas separator further comprising at least one adsorbent material in at least one contactor, fluidly connected to a multi-component fluid source to receive at least a portion of the multi-component fluid stream as at least a portion of a feed stream for the first-stage adsorptive gas separator, and fluidly connected to the multi-component fluid source to receive at least a portion of the multi-component fluid stream as a first regeneration stream, and

a second-stage adsorptive gas separator further comprising at least one adsorbent material in at least one contactor, fluidly connected to the first-stage adsorptive separator to receive a second product stream from the first-stage adsorptive separator as a feed stream for the second-stage adsorptive gas separator and fluidly connected to a steam source to receive a steam stream as a first regeneration stream.

In further embodiments according to the disclosure, a multi-stage adsorptive gas separation process for separating at least a first component from a multi-component fluid mixture is provided where the process may comprise the steps of:

admitting at least a portion of the multi-component fluid mixture at a temperature equal to or less than a first threshold temperature into a first-stage adsorptive gas separator; adsorbing at least a portion of a first component of the multi-component fluid mixture on at least one adsorbent material in a contactor in the first-stage adsorptive gas separator; increasing a temperature of the at least one adsorbent material the contactor in the first-stage adsorptive gas separator to a second threshold temperature; recovering a first product stream from the first-stage adsorptive gas separator depleted in the first component relative to the multi-component fluid mixture;

admitting a first regeneration stream for the first-stage adsorptive gas separator into the first-stage adsorptive gas separator, increasing a temperature of the at least one adsorbent material in the contactor in the first-stage adsorptive gas separator to a third threshold temperature; desorbing at least a portion of the first component adsorbed on the at least one adsorbent material in the contactor in the first-stage adsorptive gas separator; recovering a second product stream from the first-stage adsorptive gas separator enriched in the first component relative to the multi-component fluid mixture from the first-stage adsorptive gas separator;

admitting a second regeneration stream for the first-stage adsorptive gas separator at a fourth threshold temperature into the first-stage adsorptive gas separator; desorbing at least a portion of the first component adsorbed on the at least one adsorbent material in the contactor in the first-stage adsorptive gas separator; decreasing the temperature of the at least one adsorbent material in the contactor in the first-stage adsorptive gas separator to a fifth threshold temperature; recovering a third product stream enriched in the first component relative to the multi-component fluid mixture from the contactor in the first-stage adsorptive gas separator and the first-stage adsorptive gas separator;

admitting a conditioning stream for the first-stage adsorptive gas separator into the first-stage adsorptive gas separator; decreasing the temperature of the at least one adsorbent material in the contactor in the first-stage adsorptive gas separator to a sixth threshold temperature; recovering a fourth product stream from the first-stage adsorptive gas separator;

admitting at least a portion of the second product stream of the first-stage adsorptive gas separator into a second-stage adsorptive gas separator; adsorbing at least one of the first component or a second component of the multi-component fluid mixture on the at least one adsorbent material in the contactor in the second-stage adsorptive gas separator; increasing the temperature of the at least one adsorbent material in the contactor in the second-stage adsorptive gas separator to a seventh threshold temperature; recovering a first product stream from the second-stage adsorptive gas separator depleted in at least one of the first component or the second component relative to the multi-component fluid mixture from the second-stage adsorptive gas separator;

admitting a first regeneration stream for the second-stage adsorptive gas separator into the second-stage adsorptive gas separator; increasing a temperature of the at least one adsorbent material in the contactor in the second-stage adsorptive gas separator to an eighth threshold temperature; desorbing at least a portion of, one of the first component or the second component on the at least one adsorbent material in the contactor in the second-stage adsorptive gas separator; recovering a second product stream from the second-stage adsorptive gas separator depleted in one of the first component or second component relative to the multi-component fluid mixture from the contactor in the second-stage adsorptive gas separator, and the second-stage adsorptive gas separator;

admitting a second regeneration stream for the second-stage adsorptive gas separator at a ninth threshold temperature, into the second-stage adsorptive gas separator; desorbing at least a portion of, one of the first component or the second component adsorbed on the at least one adsorbent material in the contactor in the second-stage adsorptive gas separator; decreasing the temperature of the at least one adsorbent material in the contactor in the second-stage adsorptive gas separator to a tenth threshold temperature; recovering a third product stream enriched in the first component relative to the multi-component fluid mixture from the second-stage adsorptive gas separator, and

admitting a conditioning stream for the second-stage adsorptive gas separator into the second-stage adsorptive gas separator; decreasing the temperature of the at least one adsorbent material in the contactor in the second-stage adsorptive gas separator to an eleventh threshold temperature, and recovering a fourth product stream from the second-stage adsorptive gas separator.

### BRIEF DESCRIPTION OF THE DRAWINGS

The systems and methods for adsorptive gas separation of at least one component from a multi-component fluid mixture according to embodiments of the present invention will now be described with reference to the accompanying drawing FIGURES, in which:

FIG. 1 is a simplified schematic diagram of an exemplary multi-stage adsorptive gas separation system according to an embodiment of the present invention for separating carbon dioxide from a multi-component gas mixture, for example, a combustion gas stream from a fuel combustor. The exemplary multi-stage adsorptive gas separation system employs a first-stage adsorptive gas separator and a second-stage adsorptive gas separator where the first-stage and second-stage adsorptive gas separators are fluidly connected to employ and admit at least one regeneration stream having a regenerating medium which differs between the first-stage and second-stage adsorptive gas separators. The first-stage adsorptive gas separator is fluidly connected to admit a first regeneration stream having a combustion mixture as a first regenerating medium, while the second-stage adsorptive gas separator is fluidly connected to admit a first regeneration stream having steam as a first regenerating medium.

### DETAILED DESCRIPTION

According to one embodiment, a multi-stage adsorptive gas separation process, herein referred to as an “MSA process”, is provided, such as for adsorptive gas separation of a component (for example, carbon dioxide), from a multi-component fluid mixture, for example, a combustion gas stream from a fuel combustor, employing an embodiment multi-stage adsorptive gas separation system (hereinafter referred to as an “MSA system”). The embodiment MSA process may be particularly suitable for gas separation applications where: a feed stream is sourced at a low pressure, making a pressure swing adsorption process less than desirable; the feed stream comprise a low or dilute concentration of the target component, for example, about 3 volume %; the volume of the feed stream to be separated is large; a product stream high in purity, for example, greater than about 80 volume % purity, of the target component is desired; recovery of the target component is high, for example, greater than about 80%, low energy consumption is desired; and/or low operating cost is desired. Exemplary applications include, for example, post-combustion gas separation of carbon dioxide from a combustion gas stream of a combined cycle power plant.

An MSA process according to one embodiment of the present disclosure may comprise a plurality of adsorption stages, wherein at least one adsorption stage further comprise an adsorptive gas separation process, herein referred as “adsorptive process” and at least one regeneration step for desorption of at least one component adsorbed on an adsorbent material is driven primarily by desorption mechanisms such as: a temperature swing, for example, a difference in temperature of the at least one adsorbent material during the adsorbing step and first regenerating step; a partial pressure swing, for example, a difference in partial pressure or concentration of at least one component of the first regeneration stream and an equilibrium partial pressure of at least one component adsorbed on the at least one adsorbent material; and/or a difference in heat of adsorption energy, for example, the difference in heat of adsorption energy of at least one component of the first regeneration stream and at least one component adsorbed on the at least one adsorbent material. Other secondary desorption mechanisms may assist in the desorption of components from the at least one adsorbent material including, for example, temperature swing, partial pressure swing, vacuum, displacement purge and/or purge. Ane exemplary MSA process may comprise adsorption stages which further comprise other gas separation processes, adsorptive gas separation processes, and/or desorption mechanisms, for example, a pressure swing adsorptive gas separation process and/or a vacuum swing adsorptive gas separation process. An adsorptive process may be cyclic and repeated sequentially.

In one embodiment, an MSA process may employ an MSA system comprising; a plurality of an adsorptive gas separator, herein referred as “adsorptive separator”, having an individual contactor, wherein each adsorptive separator and contactor are employed for a single adsorption stage of the MSA process; a single adsorptive separator having a plurality of contactors, wherein each contactor is employed for a single adsorption stage of the MSA process, or a plurality of adsorptive separators having a plurality of contactors, wherein each adsorptive separator having a plurality of contactors are employed for a single adsorption stage of the MSA process. Contactors may be stationary or moving, for example, rotating.

In an exemplary embodiment, an MSA process, a multi-component fluid mixture, for example, a flue gas stream or a combustion gas stream from a fuel combustor, may comprise at least a first component, for example, carbon dioxide (herein referred as “CO₂”) and optionally a second component, for example, nitrogen, where the first component may be separated by adsorption from a multi-component fluid mixture. The exemplary MSA process and system may comprise a first adsorption stage or first-stage adsorption process and a second adsorption stage or a second-stage adsorption process. The first-stage adsorptive process and separator may be employed for bulk gas separation of the first component from a multi-component fluid mixture which may advantageously employ at least a first regeneration stream during a first regenerating step of the first-stage adsorptive process and separator, comprising a first regeneration medium, for example, a multi-component fluid mixture, a combustion mixture, a flue gas mixture, or a fluid mixture enriched in the first component relative to the multi-component fluid mixture or a, having low exergy, low value, and/or low cost, which may advantageously result in reducing the steam consumption and/or operating cost for regeneration of the at least one adsorbent material in the first-stage adsorptive process, first-stage adsorptive separator and MSA system. Optionally, the first-stage adsorptive process and separator may employ a second regeneration stream during an optional second regenerating step of the first-stage adsorptive process and separator, optionally comprising a second regeneration medium, for example, air, multi-component fluid mixture, a combustion mixture, a flue gas mixture, or a fluid mixture enriched in the first component relative to the multi-component fluid mixture. A product stream of the first-stage adsorptive process and separator, for example, a second product stream and/or a third product stream, comprising an elevated concentration of a first component relative to the multi-component fluid mixture, may be recovered from the first-stage adsorptive separator and admitted as a feed stream for the second-stage adsorptive process and separator, which may advantageously increase the efficiency of the adsorptive gas separation process in the second-stage adsorptive process. The second-stage adsorptive process and separator may be employ at least a first regeneration stream during a first regenerating step of the second-stage adsorptive process and separator, comprising a third regeneration medium, for example, steam, electricity, a condensable gas or solvent, which may result in a second product stream of the second-stage adsorptive process and separator comprising a high concentration or high purity of the first component, for example, greater than about 80% of the first component, or specifically greater than about 90% of the first component, or more specifically greater than about 95% of the first component. Optionally, the second-stage adsorptive process and separator may employ a second regeneration stream during an optional second regenerating step of the second-stage adsorptive process and separator, optionally comprising the second regeneration medium or a fourth regeneration medium, for example, air, multi-component fluid mixture, a combustion mixture, a flue gas mixture, or a fluid mixture enriched in the first component relative to the multi-component fluid mixture. The novel combination of at least a first-stage adsorptive process and separator and a second-stage adsorptive process and separator, employing and admitting at least one regeneration stream having a regeneration medium which differs between the first-stage adsorptive process and separator and second-stage adsorptive process and separator, for example, a first-stage adsorptive process and separator employing a regeneration medium comprising a combustion mixture and second-stage adsorptive process and separator employing a regeneration medium comprising steam, or a first-stage adsorptive process and separator employing a first regeneration medium comprising a combustion mixture and a second regeneration medium comprising air and a second-stage adsorptive process and separator employing a first regeneration medium comprising steam and a second regeneration medium comprising air, may provide for a product stream which is high in purity while advantageously increase the efficiency of the adsorptive gas separation process, and reduce the consumption of steam, energy and operating cost.

In one embodiment, the exemplary MSA system comprises an air source, a heat exchanger, a first-stage adsorptive separator, a second-stage adsorptive separator, a steam source, a coolant source and a condenser, for example, a condensing heat exchanger. An exemplary first-stage adsorptive separator may comprise a contactor for supporting at least one adsorbent material, housed in an enclosure which may optionally define a plurality of zones, for example, an adsorption zone, a first regeneration zone, a second regeneration zone, and a conditioning zone, wherein the contactor may cycle or rotate through the plurality of zones and further comprises a plurality of substantially parallel fluid flow passages oriented along a first axis of the contactor, between a first end and a second end which are axially opposed, and optionally a plurality of axially continuous thermally conductive filaments oriented substantially along the first axis of the contactor which are in direct contact with at least one adsorbent material in or on the walls of the contactor. In any of the presently disclosed embodiments, a first-stage adsorptive separator may employ any suitable adsorbent materials including but not limited to, for example, desiccant, activated carbon, carbon adsorbent, graphite, carbon molecular sieve, activated alumina, molecular sieve, aluminophosphate, silicoaluminophosphate, zeolite adsorbent, ion exchanged zeolite, hydrophilic zeolite, hydrophobic zeolite, modified zeolite, natural zeolites, faujasite, clinoptilolite, mordenite, metal-exchanged silico-aluminophosphate, uni-polar resin, bi-polar resin, aromatic cross-linked polystyrenic matrix, brominated aromatic matrix, methacrylic ester copolymer, graphitic adsorbent, carbon fiber, carbon nanotube, nano-materials, metal salt adsorbent, perchlorate, oxalate, alkaline earth metal particle, ETS, CTS, metal oxide, supported alkali carbonates, alkali-promoted hydrotalcites, chemisorbent, amine, organo-metallic reactant, and metal organic framework adsorbent materials, and combinations thereof. An exemplary second-stage adsorptive separator, may be substantially similar to the exemplary first-stage adsorptive separator, but need not be, for example, the second-stage adsorptive separator may comprise at least one adsorbent material, a plurality of zones and/or contactor configuration which differ from the first-stage adsorptive separator.

In a further embodiment, an exemplary multi-stage adsorptive gas separation process for separating at least a first component from a multi-component fluid mixture may comprise the following steps:
a. admitting a multi-component fluid stream, for example, a combustion gas stream, into a multi-stage adsorptive gas separation system as at least a portion of a feed stream and optionally as a first regeneration stream of the first-stage adsorptive gas separator;
b. optionally, admitting at least a portion of the multi-component fluid stream as at least a portion of the feed stream for the first-stage adsorptive gas separator into a hot circuit of a heat exchanger, decreasing the temperature of the at least a portion of the feed stream for the first-stage adsorptive gas separator to equal to or less than a first threshold temperature, recovering the at least a portion of the feed stream for the first-stage adsorptive gas separator from the hot circuit of the heat exchanger;
c. admitting the at least a portion of the feed stream, at a temperature equal to or less than a first threshold temperature, for the first-stage adsorptive gas separator into the first-stage adsorptive gas separator, and into a first end of a contactor in the first-stage adsorptive gas separator; adsorbing at least a portion of a first component of the feed stream of the first-stage adsorptive gas separator on the at least one adsorbent material in the contactor in the first-stage adsorptive gas separator; increasing the temperature of the at least one adsorbent material in the contactor in the first-stage adsorptive gas separator to a second threshold temperature; recovering a first product stream of the first-stage adsorptive gas separator (at least periodically depleted in a first component relative to the multi-component fluid mixture and/or feed stream for the first-stage adsorptive gas separator) from a second end of the contactor in the first-stage adsorptive gas separator, the first-stage adsorptive gas separator and the multi-stage adsorptive gas separation system;
d. admitting a first regeneration stream for the first-stage adsorptive gas separator having a first regeneration medium, for example, the multi-component fluid mixture or a combustion mixture, into the first-stage adsorptive gas separator, and optionally into the second end of the contactor in the first-stage adsorptive gas separator; increasing the temperature of the at least one adsorbent material in the contactor in the first-stage adsorptive gas separator, from a second threshold temperature achieved in step c., to a third threshold temperature; desorbing at least a portion of the first component adsorbed on the at least one adsorbent material in the contactor in the first-stage adsorptive gas separator; recovering a second product stream of the first-stage adsorptive gas separator enriched in the first component relative to the multi-component fluid mixture and/or feed stream for the first-stage adsorptive gas separator optionally from the first end of the contactor in the first-stage adsorptive gas separator, and the first-stage adsorptive gas separator;
e. supplying a second regeneration stream for the first-stage adsorptive gas separator and a second-stage adsorptive gas separator, and a conditioning stream for the first-stage adsorptive gas separator and the second-stage adsorptive gas separator, for example, an air stream or a fluid stream comprising substantially the second component, optionally from a single or common supply or source, for example, an ambient air supply, fan, or inert gas supply;
f. optionally, admitting the second regeneration stream into a cold circuit of the heat exchanger; increasing the temperature of the second regeneration stream to a fourth threshold temperature, recovering the second regeneration stream from the cold circuit of the heat exchanger;
g. admitting the second regeneration stream for the first-stage adsorptive gas separator having a second regeneration medium, for example, air, at a fourth threshold temperature into the first-stage adsorptive gas separator and optionally the first end of the contactor in the first-stage adsorptive gas separator; desorbing at least a portion of the first component adsorbed on the at least one adsorbent material in the contactor in the first-stage adsorptive gas separator; decreasing the temperature of the at least one adsorbent material in the contactor in the first-stage adsorptive gas separator to a fifth threshold temperature; recovering a third product stream of the first-stage adsorptive gas separator enriched in the first component relative to the multi-component fluid mixture and/or feed stream for the first-stage adsorptive gas separator optionally from the second end of the contactor in the first-stage adsorptive gas separator and optionally the first-stage adsorptive gas separator; admitting and optionally combining the third product stream of the first-stage adsorptive gas separator as a portion of the feed stream for the first-stage adsorptive gas separator into the first-stage adsorptive gas separator and into the first end of the contactor in the first-stage adsorptive gas separator;
h. optionally, admitting the conditioning stream for the first-stage adsorptive gas separator into the first-stage adsorptive gas separator and optionally the first end of the contactor in the first-stage adsorptive gas separator; decreasing the temperature of the at least one adsorbent material in the contactor in the first-stage adsorptive gas separator to a sixth threshold temperature; recovering a fourth product stream of the first-stage adsorptive gas separator optionally from the second end of the contactor in the first-stage adsorptive gas separator, the first-stage adsorptive gas separator, and the multi-stage adsorptive gas separation system;
i. admitting at least a portion of the second product stream of the first-stage adsorptive gas separator as at least a portion of a feed stream for the second-stage adsorptive gas separator into the second-stage adsorptive gas separator and into a first end of the contactor in the second-stage adsorptive gas separator; adsorbing at least a portion of the first component or a second component of the multi-component fluid mixture and/or feed stream for the second-stage adsorptive gas separator on at least one adsorbent material in the contactor in the second-stage adsorptive gas separator; increasing the temperature of the at least one adsorbent material in the contactor in the second-stage adsorptive gas separator to a seventh threshold temperature; recovering a first product stream of the second-stage adsorptive gas separator (at least periodically depleted in at least one of the first component or second component relative to the multi-component fluid mixture and/or feed stream for the second-stage adsorptive gas separator), from a second end of the contactor in the second-stage adsorptive gas separator, the second-stage adsorptive gas separator and the multi-stage adsorptive gas separation system;
j. supplying a first regeneration stream for the second-stage adsorptive gas separator, for example, a steam stream; admitting the first regeneration stream for the second-stage adsorptive gas separator having a third regeneration medium, for example, water, into the second-stage adsorptive gas separator, and optionally into a second end of the contactor in the second-stage adsorptive gas separator; increasing the temperature of the at least one adsorbent material in the contactor in the second-stage adsorptive gas separator to an eighth threshold temperature; desorbing at least a portion of one of the first component or the second component on the at least one adsorbent material in the contactor in the second-stage adsorptive gas separator; recovering a second product stream of the second-stage adsorptive gas separator depleted in the first component or second component relative to the multi-component fluid mixture and/or feed stream of the second-stage adsorptive gas separator optionally from the first end of the contactor in the second-stage adsorptive gas separator, and the second-stage adsorptive gas separator;
k. admitting a second product stream of the second-stage adsorptive gas separator into a condensing heat exchanger, decreasing the temperature of the second product stream of the second-stage adsorptive gas separator forming a second product stream high in purity and a condensate stream; recovering the second product stream high in purity from the condensing heat exchanger and the multi-stage adsorptive gas separation system; recovering the condensate stream from the condensing heat exchanger and the multi-stage adsorptive gas separation system;
l. admitting the second regeneration stream for the second-stage adsorptive gas separator having the second regeneration medium at a ninth threshold temperature, into the second-stage adsorptive gas separator, and optionally into the first end of the contactor in the second-stage adsorptive gas separator; desorbing at least a portion of one of the first component or the second component adsorbed on the at least one adsorbent material in the contactor in the second-stage adsorptive gas separator; decreasing the temperature of the at least one adsorbent material in the contactor in the second-stage adsorptive gas separator to a tenth threshold temperature; recovering a third product stream of the second-stage adsorptive gas separator enriched in the first component or the second component relative to the multi-component fluid mixture and/or feed stream of the second-stage adsorptive gas separator optionally from the second end of the contactor in the second-stage adsorptive gas separator, and optionally the second-stage adsorptive gas separator; admitting the third product stream of the second-stage adsorptive gas separator as a portion of the feed stream for the first-stage adsorptive gas separator into the first-stage adsorptive gas separator and into the first end of the contactor in the first-stage adsorptive gas separator;
m. admitting the conditioning stream for the second-stage adsorptive gas separator into the second-stage adsorptive gas separator and the first end of the contactor in the second-stage adsorptive gas separator; decreasing the temperature of the at least one adsorbent material in the contactor in the second-stage adsorptive gas separator to an eleventh threshold temperature, and recovering a fourth product stream of the second-stage adsorptive gas separator from the second end of the contactor in the second-stage adsorptive gas separator, the second-stage adsorptive gas separator, and the multi-stage adsorptive gas separation system.

In one such embodiment, of the exemplary MSA process, the first threshold temperature may be for example, about 50° C., or specifically about 40° C., or more specifically about 30° C.; the second threshold temperature may be greater than the first threshold temperature; the third threshold temperature may be greater than the second threshold temperature; the fourth threshold temperature may be equal to or less than the third threshold temperature and equal to or greater than the second threshold temperature; the fifth threshold temperature may be equal to or greater than the second threshold temperature; the sixth threshold temperature may be equal to or less than the second threshold temperature; the seventh threshold temperature may be greater than the second threshold temperature; the eighth threshold temperature may be greater than the seventh threshold temperature; the ninth threshold temperature may be equal to or less than the eighth threshold temperature; the tenth threshold temperature may be equal to or less than the ninth threshold temperature; the eleventh threshold temperature may be equal to or less than the tenth threshold temperature and the sixth threshold temperature, and a change in temperature between the second threshold temperature and the third threshold temperature may be equal to or greater that a change in temperature between the seventh threshold temperature and the eighth threshold temperature.

In a further embodiment, in an exemplary MSA process, a multi-component fluid mixture may further comprise, a combustion gas mixture, a flue gas mixture, a product stream from another gas separation process or natural gas; the first component may be any one of, carbon dioxide, oxygen or a contaminant including, for example, sulfur oxides, nitrogen oxides, particulate matter and a heavy metal, such as, mercury and beryllium; the second component may be any one of, nitrogen, carbon dioxide, oxygen, or a contaminant including, for example, sulfur oxides, nitrogen oxides, particulate matter and a heavy metal, such as, mercury and beryllium; the first regeneration stream and/or the second regeneration stream may optionally be low in exergy and/or optionally recovered as at least a portion of an output fluid stream or exhaust fluid stream of a process which the MSA process is integrated with, the first regeneration medium may further comprise, a product mixture from another gas separation process and/or separator, a condensable gas or solvent, air, carbon dioxide, water in the form of steam or electricity; the second regeneration medium may further comprise, a multi-component fluid mixture, a combustion gas mixture, a flue gas mixture, air, an inert gas, carbon dioxide, a product mixture from another gas separation process and/or device, a condensable gas, water in the form of steam or electricity, and the third regeneration medium may further comprise air, an inert gas or carbon dioxide.

In one such embodiment, step c. of the exemplary MSA process may be representative of an adsorbing step of a first-stage adsorptive process; step d. may be representative of a first regenerating step of the first-stage adsorptive process; step g. may be representative of an optional second regenerating step of the first-stage adsorptive process; step h. may be representative of an optional conditioning step of the first-stage adsorptive process; step i. may be representative of an adsorbing step of a second-stage adsorptive process; step j. and optionally step k. may be representative of a first regenerating step of a second-stage adsorptive process; step l. may be representative of an optional second regenerating step of a second-stage adsorptive process; step m. may be representative of an optional conditioning step of a second-stage adsorptive process; the steps of a. through m. may occur substantially simultaneously in a MSA process and MSA system; the steps of c., d., g., h., i., j., l., and m., may occur substantially simultaneously in a MSA process and MSA system; the steps of c., d., i., and j., may occur substantially simultaneously in a MSA process and MSA system; the steps of c., d., g., and h., may occur sequentially and cyclically repeated in any stage of an adsorptive process and separator; the steps of i., j., l., and m., may occur sequentially and cyclically repeated in any stage of an adsorptive process and separator.

In an alternative embodiment, in an exemplary MSA process: a plurality of adsorptive stages may be employed, for example, steps b through h and/or steps i though m, for a MSA process; a adsorptive stage may comprise an adsorbing step and a regenerating step, for example, steps b and c or steps i and j; a second regeneration stream admitted into a first adsorption stage or a first-stage adsorptive gas separator may be a different medium than a second regeneration stream admitted into a second adsorption stage or a second-stage adsorptive gas separator; a first regeneration stream admitted into a first adsorption stage or a first-stage adsorptive gas separator and a second adsorption stage or a second-stage adsorptive gas separator may further comprise a same regeneration medium, while a second regeneration stream admitted into a first adsorption stage or a first-stage adsorptive gas separator and a second adsorption stage or a second-stage adsorptive gas separator may further comprise different regeneration mediums; the fluid streams, for example, feed stream, first regeneration stream, second regeneration stream, conditioning stream, may be admitted into a zone, for example adsorption zone, first regeneration zone, second regeneration zone, conditioning zone, within a adsorptive gas separator, prior to admitting the fluid stream into a contactor within the adsorptive gas separator; and an adsorption stage of a MSA process may provide for adsorptive gas separation of a different component from a multi-component mixture, for example, in an embodiment MSA process and system, a first-stage adsorptive process and separator may provide for adsorptive gas separation of a contaminant, for example, sulfur oxides, nitrogen oxides, particulate matter and a heavy metal, such as, mercury and beryllium, from a multi-component mixture, while at least a second-stage adsorptive process and separator may provide for adsorptive gas separation of CO₂, oxygen, nitrogen or a contaminant, from the multi-component mixture. Periodically, for example, when a pre-determined threshold has been achieved, for example, breakthrough of the first product stream from the second end of the contactor, a pre-determined temperature at or near the second end of the contactor, or at a pre-determined time, a portion of the first product stream, which may be partially enriched with the first component, may optionally be recycled and admitted into the adsorptive separator and the first end of at least one contactor as a portion of the feed stream for the adsorption step which may advantageously increase the recovery of the first component from the feed stream, for example, a first product stream from a first-stage adsorptive separator may be recycled and admitted as a portion of a feed stream into the first-stage adsorptive gas separator, and a first product stream from a second-stage adsorptive separator may be recycled and admitted as a portion of a feed stream into the first-stage and/or the second-stage adsorptive gas separator. Optionally, a second product stream may be recovered from the second-stage adsorptive gas separator and admitted into a condensing heat exchanger, a pump, for example, an ejector, a vacuum pump, or a single stage or multistage compressor operating at sub-ambient inlet pressure and an optional valve, for example, a check valve, where the pump may assist in reducing the pressure and maintaining the reduced pressure in the condensing heat exchanger. Optionally, a second product stream may be recovered from the second-stage adsorptive gas separator and admitted into a plurality of condensing heat exchangers and pumps, fluidly connected in series. Optionally, an adsorptive process and separator employing adsorbents, for example, supported alkali carbonates, and alkali-promoted hydrotalcites, suitable for high temperatures, a feed stream admitted into an adsorptive process and separator may be at a temperature equal to or less than a first threshold temperature of about 200° C.

In a process embodiment according to the present disclosure, an optional pre-regenerating step may be optionally employed in one or more adsorptive stage of a MSA process to increase the quantity of a component, for example, the first component or second component, adsorbed on the at least one adsorbent material subsequent to an adsorbing step, for example, step c. and/or step i, and prior to a first regenerating step, for example, step d. and/or step j., which may result in increasing the concentration or purity of a second product stream recovered from an adsorptive separator and contactor during the first regenerating step. During a pre-regenerating step, a pre-regeneration stream may be employed optionally comprising at least a portion of a first regeneration stream, or optionally steam stream, and may optionally be recovered from a first regeneration stream source and admitted into the adsorptive separator, and at least one contactor, to optionally enter the second end of the contactor to optionally flow in a direction substantially towards the first end of the contactor or in a counter-flow direction to the direction of flow of the feed stream. The pre-regeneration stream may desorb at least a portion of the second component or other diluent fluid components which may be undesirably co-adsorbed on the at least one adsorbent material, forming a heavy reflux stream which may be enriched in one of the first component or second component relative to the feed stream. The heavy reflux stream may be recovered optionally from the first end of the contactor, recycled and admitted into the contactor prior to an adsorbing step, for example, step c. and/or step i., or after an adsorbing step.

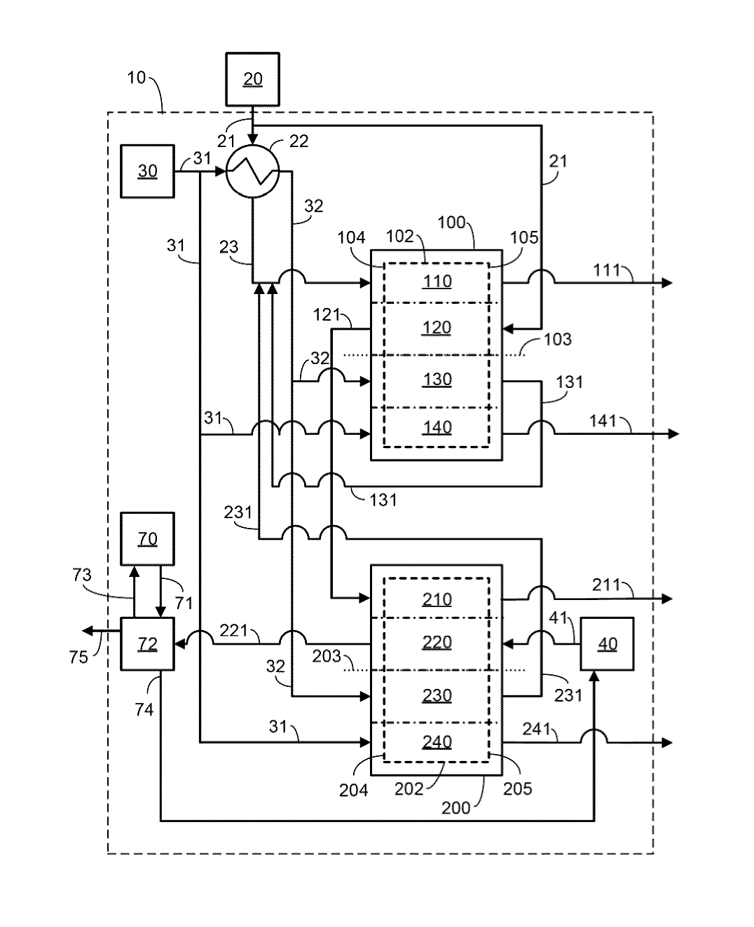

FIG. 1 is a simplified schematic diagram of an exemplary multi-stage adsorptive gas separation system or a MSA system 10 according to an embodiment of the present disclosure, in which the MSA system 10 comprises an optional heat exchanger or a HEX 22, a fan 30, a first-stage adsorptive gas separator or first-stage adsorptive separator 100, a second-stage adsorptive gas separator or second-stage adsorptive separator 200, a steam source 40, a coolant source 70 and a condensing heat exchanger or CHEX 70, suitable for the embodiment multi-stage adsorptive gas separation process or MSA process described above. The exemplary embodiment multi-stage adsorptive gas separation system may be employed for adsorptive separation of at least one component from a multi-component fluid mixture, for example, adsorptive gas separation of carbon dioxide and/or sulfur oxides from a combustion gas stream.

First-stage adsorptive separator 100 comprises a contactor 102 housed in an enclosure (not shown in FIG. 1) which may assist in defining a plurality of stationary zones, for example, an adsorption zone 110, a first regeneration zone 120, a second regeneration zone 130 and a conditioning zone 140, where the zones are substantially fluidly separate to each other within contactor 105 and enclosure (not shown in FIG. 1). Contactor 105 further comprises a plurality of substantially parallel fluid flow passages (not shown in FIG. 1) oriented substantially parallel to a first axis 103, between a first end 104 and a second end 105 which are axially opposed, and optionally a plurality of continuous thermally conductive filaments (not shown in FIG. 1) oriented substantially parallel to first axis 103, which are in direct contact with at least one adsorbent material (not shown in FIG. 1) in or on the walls (not shown in FIG. 1) of contactor 102. Contactor 102 may be powered by any suitable mechanical device (not shown in FIG. 1), for example, an electric motor (not shown in FIG. 1), which may cycle or rotate a point on contactor 102, substantially continuously or intermittently and through adsorption zone 110, first regeneration zone 120, second regeneration zone 130, and conditioning zone 140.

Second-stage adsorptive separator 200 comprises a contactor 202 housed in an enclosure (not shown in FIG. 1) which may assist in defining a plurality of stationary zones, for example, an adsorption zone 210, a first regeneration zone 220, a second regeneration zone 230 and a conditioning zone 240, where the zones are substantially fluidly separate to each other within contactor 202 and enclosure (not shown in FIG. 1). Contactor 202 further comprises a plurality of substantially parallel fluid flow passages (not shown in FIG. 1) oriented substantially parallel to a first axis 203, between a first end 204 and a second end 205 which are axially opposed, and optionally a plurality of continuous thermally conductive filaments (not shown in FIG. 1) oriented substantially parallel to first axis 203, which are in direct contact with at least one adsorbent material (not shown in FIG. 1) in or on the walls (not shown in FIG. 1) of contactor 202. Contactor 202 may be powered by any suitable mechanical device (not shown in FIG. 1), for example, an electric motor (not shown in FIG. 1), which may cycle or rotate a point on contactor 202, substantially continuously or intermittently and through adsorption zone 210, first regeneration zone 220, second regeneration zone 230, and conditioning zone 240.

In one embodiment, first-stage adsorptive separator 100 is fluidly connected to a multi-component fluid source to receive at least a portion of a multi-component fluid stream as at least a portion of a feed stream and optionally as a first regeneration stream for first-stage adsorptive separator 100. Second-stage adsorptive separator 200 is fluidly connected to first-stage adsorptive separator 100 to receive a second product stream from first-stage adsorptive separator 100 as a feed stream for second-stage adsorptive separator 200. Second-stage adsorptive separator 200 is also fluidly connected to a first regeneration stream source, for example, a steam source or a low or very low pressure stage of a multistage steam turbine, to receive a steam stream as a first regeneration stream. First-stage adsorptive separator 100 and second-stage adsorptive separator 200 are fluidly connected to an air source or a fan, via a heat exchanger to receive a portion of an air stream as a second regeneration stream. First-stage adsorptive separator 100 and second-stage adsorptive separator 200 are fluidly connected to the air source or the fan to receive a portion of the air stream as a conditioning stream.

In one embodiment, a multi-component fluid mixture source, for example, a fuel combustor, or a combustor 20, is fluidly connected to admit a multi-component fluid mixture or multi-component fluid stream, for example, a combustion gas stream 21, into MSA system 10. First-stage adsorptive separator 100 is fluidly connected to receive at least a portion of the multi-component fluid stream or combustion gas stream 21, as at least a portion of a feed stream via a hot circuit (not shown in FIG. 1) of HEX 22, and at least a portion of the multi-component fluid stream or combustion gas stream 21 as a first regeneration stream. Combustion gas stream 21 may be at a temperature, for example, about 40-200° C., or specifically about 70-170° C., or more specifically about 80-140° C., may supply and transfer heat to HEX 22, decreasing the temperature of combustion gas stream 21 and forming a combustion gas stream 23 at a temperature equal to or less than a first threshold temperature, for example, about 50° C., or specifically about 40° C., or more specifically about 30° C. Combustion gas stream 23 may be recovered from the hot circuit (not shown in FIG. 1) of HEX 22 and admitted as at least a portion of a feed stream into first-stage adsorptive separator 100, adsorption zone 110, and a portion of contactor 102 within adsorption zone 110, to flow in a direction substantially from first end 104 to second end 105 of contactor 102. As combustion gas stream 23 contacts the at least one adsorbent material (not shown in FIG. 1) in a portion of contactor 102 within adsorption zone 110, a first component, for example, CO₂, may adsorb on the at least one adsorbent material (not shown in FIG. 1), separating the first component from combustion gas stream 23. During adsorption of the first component, the heat of adsorption may increase the temperature of the at least one adsorbent material (not shown in FIG. 1) in a portion of contactor 102 within adsorption zone 110, to a second threshold temperature, for example, greater than the first threshold temperature. A portion of combustion gas stream 23 and/or the non-adsorbed components may form a first product stream 111, which may be depleted in the first component relative to the multi-component fluid stream, or feed stream for first-stage adsorptive separator 100, for example, combustion gas stream 21 and combustion gas stream 23, and may be recovered from second end 105 of a portion of contactor 102 within adsorption zone 110, adsorption zone 110, first-stage adsorptive separator 100 and MSA system 10. Adsorption zone 110, first-stage adsorptive separator 100 and MSA system 10 may be fluidly connected to direct first product stream 111 to, for example, a stack (not shown in FIG. 1) for dispersion and release into the ambient environment, to another gas separation process, or to an industrial process (all not shown in FIG. 1). Optionally, second end 105 of a portion of contactor 102 within adsorption zone 110, may be fluidly connected to first end 104 of a portion of contactor 102 within adsorption zone 110, to periodically recycle and admit first product stream 111 as a portion of a feed stream or combustion gas stream 23 into first end 104 of a portion of contactor 102 within adsorption zone 110 and adsorption zone 110.

In one embodiment, a first regeneration stream of first-stage adsorptive separator 100 may comprise a first regeneration medium, for example, a combustion mixture or a flue gas mixture from a fuel combustor, or a fluid stream comprising at least a first component. A portion of the multi-component fluid stream or a portion of combustion gas stream 21 may be admitted as a first regeneration stream into first-stage adsorptive separator 100, first regeneration zone 120, and a portion of contactor 102 within first regeneration zone 120, to optionally flow in a direction substantially from second end 105 to first end 104 of contactor 102 or in a substantially counter-flow direction in relation to the direction of flow of the feed stream of first-stage adsorptive separator 100 or combustion gas stream 23 in a portion of contactor 102 within adsorption zone 110. Combustion gas stream 21 may contact and increase the temperature of the at least one adsorbent material (not shown in FIG. 1) within first regeneration zone 120 to a third threshold temperature, for example, greater than the second threshold temperature, desorbing at least a portion of the first component, for example, CO₂, adsorbed on the at least one adsorbent material (not shown in FIG. 1) in a portion of contactor 102 within adsorption zone 110. A portion of combustion gas stream 23 and/or desorbed components, for example, first component, may form a second product stream 121, which may be enriched in the first component relative to the feed stream of first-stage adsorptive separator 100, for example, combustion gas stream 21 and combustion gas stream 23. Second-stage adsorptive separator 200 and adsorption zone 210 may be fluidly connected to receive second product stream 121 from first-stage adsorptive separator 100, first regeneration zone 120 and first end 104 of a portion of contactor 102 as a feed stream for second-stage adsorptive separator 200. First regeneration zone 120 and first-stage adsorptive separator 100 may be fluidly connected to admit second product stream 121 of first-stage adsorptive separator 100 as a feed stream for second-stage adsorptive separator 200 into second-stage adsorptive separator 200 and adsorbing zone 210.

First-stage adsorptive separator 100 may be employed to provide for bulk-gas separation of the first component, which may advantageously enable employment of a portion of combustion gas stream 21, which may be low in exergy and low in value, as a first regeneration stream and a multi-component fluid mixture or a combustion mixture as a first regeneration medium, resulting in reducing the consumption of steam in MSA system 100. Directing and admitting second product stream 121 of first-stage adsorptive separator 100 having an increased concentration of the first component, for example, about 16-24 volume % CO₂, or specifically about 18-22 volume % CO₂, as a feed stream for second-stage adsorptive separator 200 into second-stage adsorptive separator 200 and adsorbing zone 210 may increase the adsorption efficiency of the second-stage adsorptive separator 200 and assist in recovering a high concentration or high purity product stream comprising the first component, for example, greater than about 80 volume % CO₂, or specifically, greater than about 90 volume % CO₂, or more specifically, greater than about 95% volume % CO₂, from second-stage adsorptive separator 200 and MSA system 100.

In one embodiment, a second regeneration stream for first-stage adsorptive separator 100 and second-stage adsorptive separator 200 may employ a second regeneration medium, for example, air. An air source, for example, an air fan fluidly connected to an ambient environment, or a fan 30, may be fluidly connected to admit at least a portion of air steam 31, into cold circuit (not shown in FIG. 1) of HEX 22 as a second regeneration stream for first-stage adsorptive separator 100 and second-stage adsorptive separator 200, and at least a portion of air steam 31, as a conditioning stream into conditioning zone 140 for first-stage adsorptive separator 100 and as a conditioning stream into conditioning zone 240 for second-stage adsorptive separator 200. Optionally, a separate second regeneration stream source and a separate conditioning stream source, supplying different streams or mediums may be employed. A portion of air steam 31 admitted into cold circuit (not shown in FIG. 1) of HEX 22 may transfer heat from HEX 22, increasing the temperature of air stream 31, and forming an air stream 32. A portion of air stream 32 may be admitted as a second regeneration stream, at a temperature of a fourth threshold temperature, for example, equal to or less than the third threshold temperature, into first-stage adsorptive separator 100, second regeneration zone 130 and a portion of contactor 102 within second regeneration zone 130, to flow in an optional direction substantially from first end 104 to second end 105 of contactor 102 or in a substantially co-current flow direction in relation to the direction of flow of the feed stream for first-stage adsorptive separator 100 or combustion gas stream 23 in a portion of contactor 102 within adsorption zone 110. Air stream 32 may contact and desorb at least a portion of the first component, for example, CO₂, adsorbed on the at least one adsorbent material (not shown in FIG. 1) in a portion of contactor 102 within second regeneration zone 130 and decrease the temperature of the at least one adsorbent material (not shown in FIG. 1) in a portion of contactor 102 within second regeneration zone 130, to a fifth threshold temperature, for example, equal to or greater than the second threshold temperature. A portion of the air stream 32 and/or desorbed components for example, first component, may form a third product stream 131 which may be enriched in the first component relative to the multi-component fluid stream or feed stream for first-stage adsorptive separator 100, for example, combustion gas stream 21 and combustion gas stream 23. Third product stream 131 of first-stage adsorptive separator 100 may be recovered optionally from second end 105 of a portion of contactor 102 within second regeneration zone 130, second regeneration zone 130, and first-stage adsorptive separator 100. Second regeneration zone 130 of first-stage adsorptive separator 100 may be fluidly connect to admit third product stream 131 of first-stage adsorptive separator 100, to optionally combine with combustion gas stream 23, as a portion of the feed stream for first-stage adsorptive separator 100 into first-stage adsorptive separator 100 and adsorption zone 110, which may advantageously assist to increase the recovery rate of the first component from the multi-component fluid mixture and MSA system 10.

In one embodiment, at least a portion of air steam 31 may be admitted as a conditioning stream into first-stage adsorptive separator 100, conditioning zone 140, and a portion of contactor 102 within conditioning zone 140, to flow optionally in a direction substantially from first end 104 to second end 105 of contactor 102, or in a substantially co-current flow direction in relation to the direction of flow of the feed stream for first-stage adsorptive separator 100 or combustion gas stream 23 in a portion of contactor 102 within adsorption zone 110. Air stream 31 may purge residual components and decrease the temperature of the at least one adsorbent material (not shown in FIG. 1) in a portion of contactor 102 within conditioning zone 140, to a sixth threshold temperature, for example, equal to or less than the second threshold temperature. A portion of the air stream 31, desorbed and/or purged components, for example, first component, may form a fourth product stream 141 which may be depleted in the first component relative to the multi-component fluid mixture or feed stream for first-stage adsorptive separator 100, for example, combustion gas stream 21 and combustion gas stream 23. Fourth product stream 141 may be recovered from second end 105 of a portion of contactor 102 within conditioning zone 140, conditioning zone 140, first-stage adsorptive separator 100 and MSA system 10. Conditioning zone 140, first-stage adsorptive separator 100 and MSA system 10 may be fluidly connected to direct fourth product stream 141 to, for example, a stack for dispersion and release into the ambient environment, to another gas separation process, or to an industrial process (all not shown in FIG. 1).

In one embodiment, second product stream 121 of first-stage adsorptive separator 100 may be admitted as at least a portion of a feed stream into second-stage adsorptive separator 200, adsorption zone 210, and a portion of contactor 202 within adsorption zone 210, to flow in a direction substantially from first end 204 to second end 205 of contactor 202. As second product stream 121 of first-stage adsorptive separator 100 contacts the at least one adsorbent material (not shown in FIG. 1) in a portion of contactor 202 within adsorption zone 210, at least one of a first component, for example, CO₂, or a second component may adsorb on the at least one adsorbent material (not shown in FIG. 1), separating at least one of the first component or second component from the feed stream or second product stream 121 of first-stage adsorptive separator 100. During adsorption of the at least one of the first component or second component, the heat of adsorption may increase the temperature of the at least one adsorbent material (not shown in FIG. 1) in a portion of contactor 202 within adsorption zone 210, to a seventh threshold temperature, for example, greater than the second threshold temperature. The non-adsorbed components may form a first product stream 211 of second-stage adsorptive separator 200, which may depleted in the first component or second component relative to the multi-component fluid mixture or feed stream for first-stage adsorptive separator 100, for example, combustion gas stream 21 and combustion gas stream 23, and may be recovered optionally from second end 205 of a portion of contactor 202 within adsorption zone 210, adsorption zone 210, second-stage adsorptive separator 200 and MSA system 10. Adsorption zone 210, second-stage adsorptive separator 200 and MSA system 10 may be fluidly connected to direct first product stream 211 to, for example, a stack (not shown in FIG. 1) for dispersion and release into the ambient environment, to another gas separation process, or to an industrial process (all not shown in FIG. 1). Optionally, second end 205 of a portion of contactor 202 within adsorption zone 210, may be fluidly connected to first end 204 of a portion of contactor 202 within adsorption zone 210 to periodically recycle and admit first product stream 211 as a portion of a feed stream or second product stream 121 of first-stage adsorptive separator 100 into first end 204 of a portion of contactor 202 within adsorption zone 210. Optionally, second end 205 of a portion of contactor 202 within adsorption zone 210 of second-stage adsorptive separator 200, may be fluidly connected to first end 104 of a portion of contactor 102 within adsorption zone 110 of first-stage adsorptive separator 100, to periodically recycle and admit first product stream 211 as a portion of a combustion gas stream 23 or a feed stream of first-stage adsorptive separator 100.

In one embodiment, a first regeneration stream of second-stage adsorptive separator 200 may comprise a third regeneration medium, for example, water in the form of steam. A steam source 40, for example, a steam turbine, a very low pressure steam turbine, a boiler, a heat recovery steam generator or a steam generator, may produce a steam stream 41 and be fluidly connected to admit steam stream 41, as a first regeneration stream of second-stage adsorptive separator 200 into second-stage adsorptive separator 200, first regeneration zone 220, and a portion of contactor 202 within first regeneration zone 220, to optionally flow in a direction substantially from second end 205 to first end 204 of contactor 202 or in a substantially counter-flow direction in relation to the direction of flow of the feed stream for second-stage adsorptive separator 200 or second product stream 121 of first-stage adsorptive separator 100 in a portion of contactor 202 within adsorption zone 210. Steam stream 41 may contact and increase the temperature of the at least one adsorbent material (not shown in FIG. 1) in a portion of contactor 202 within first regeneration zone 220 to an eighth threshold temperature, for example, greater than the seventh threshold temperature, desorbing at least a portion of the first component, for example, CO₂, adsorbed on the at least one adsorbent material (not shown in FIG. 1) in a portion of contactor 202 within first regeneration zone 220. A portion of steam stream 41 and/or desorbed components, for example, first component, may form a second product stream 221, which may be enriched in at least one of the first component or second component relative to the feed stream for second-stage adsorptive separator, for example, second product stream 121. Second product stream 221 of second-stage adsorptive separator 200 may be recovered optionally from first end 204 of a portion of contactor 202 within first regeneration zone 220, first regeneration zone 220 and second-stage adsorptive separator 200.

A coolant source 70 may be fluidly connected to admit a coolant stream 71 into a cold circuit (not shown in FIG. 1) of CHEX 72 and recover a coolant stream 73 from the cooling circuit (not shown in FIG. 1) of CHEX 72, to transfer and remove heat from CHEX 72. First regeneration zone 220 and second-stage adsorptive separator 200 may be fluidly connected to admit second product stream 221 of second-stage adsorptive separator 200 into a hot circuit (not shown in FIG. 1) of condensing heat exchanger 70 to reduce the temperature of second product stream 221, causing condensable components, for example, third component or H₂O, to condense, forming a condensate stream 74 and a second product stream 75 high in purity in the first component or second component. As the condensable component condenses, a reduction in pressure or vacuum may occur and may be maintained in the hot circuit (not shown in FIG. 1) of CHEX 72 and the fluidly connected first regeneration zone 220 of second-stage adsorptive separator 200, and a portion of contactor 202 within first regeneration zone 220, which may advantageously enable vacuum assisted desorption of components, for example, first component or second component, adsorbed on the at least one adsorbent material (not shown in FIG. 1) in a portion of contactor 202 within first regeneration zone 220. Hot circuit (not shown in FIG. 1) of CHEX 72 may be fluidly connected to recover second product stream 75 from CHEX 72, and MSA system 10, for admittance into a compressor and/or an end use (both not shown in FIG. 1) for second product stream 75. Optionally, hot circuit (not shown in FIG. 1) of CHEX 72 may be fluidly connected to recover second product stream 75 from CHEX 72 and admit second product stream 75 into an optional pump or ejector (not shown in FIG. 1) and/or at least a second-stage condensing heat exchanger (not shown in FIG. 1) prior to admittance into a compressor and/or an end use (both not shown in FIG. 1) for second product stream 75. Optionally, hot circuit (not shown in FIG. 1) of CHEX 72 may be fluidly connected to admit condensate stream 74 as a portion of a water employed to produce steam stream 41 by steam source 40.

In one embodiment, a second regeneration stream of second-stage adsorptive separator 200 may comprise the second regeneration medium, for example, air. A portion of air stream 32 may be admitted as a second regeneration stream for second-stage adsorptive separator 200 at a temperature of a ninth threshold temperature, for example, equal to or less than the eighth threshold temperature, into second-stage adsorptive separator 200, second regeneration zone 230 and a portion of contactor 202 within second regeneration zone 230, to flow optionally in a direction substantially from first end 204 to second end 205 of contactor 202 or in a substantially co-current flow direction in relation to the direction of flow of the feed stream for second-stage adsorptive separator 200 or second product stream 121, in a portion of contactor 202 within adsorption zone 210. Air stream 32 may contact and desorb at least a portion of the first component or second component adsorbed on the at least one adsorbent material (not shown in FIG. 1) in a portion of contactor 202 within second regeneration zone 230 and decrease the temperature of the at least one adsorbent material (not shown in FIG. 1) in a portion of contactor 202 within second regeneration zone 230, to a tenth threshold temperature, for example, equal to or less than the ninth threshold temperature. A portion of the air stream 32 and/or desorbed components for example, first component or second component, may form a third product stream 231 which may be enriched in the first component or second component relative to the multi-component fluid stream or feed stream for first-stage adsorptive separator 100, for example, combustion gas stream 21 and combustion gas stream 23. Third product stream 231 may be recovered optionally from second end 205 of a portion of contactor 202 within second regeneration zone 230, second regeneration zone 230, and second-stage adsorptive separator 200. Second regeneration zone 230 of second-stage adsorptive separator 200 may be fluidly connect to admit third product stream 231 of second-stage adsorptive separator 200, to optionally combine with combustion gas stream 23, as a portion of the feed stream for first-stage adsorptive separator 100 into first-stage adsorptive separator 100 and adsorption zone 110, which may advantageously assist to increase the recovery rate of the first component from the multi-component fluid stream and MSA system 10.

In one embodiment, at least a portion of air steam 31 may be admitted as a conditioning stream into second-stage adsorptive separator 200, conditioning zone 240, and a portion of contactor 202 within conditioning zone 240, to flow optionally in a direction substantially from first end 204 to second end 205 of contactor 202, or in a substantially co-current flow direction in relation to the direction of flow of the feed stream for second-stage adsorptive separator 200 or second product stream 121, in a portion of contactor 202 within adsorption zone 210. Air stream 31 may purge residual components and decrease the temperature of the at least one adsorbent material (not shown in FIG. 1) in a portion of contactor 202 within conditioning zone 240, to a eleventh threshold temperature, for example, equal to or less than the tenth threshold temperature. A portion of the air stream 31, desorbed and/or purged components, for example, first component, may form a fourth product stream 241 which may be depleted in the first component relative to the multi-component fluid mixture or feed stream for first-stage adsorptive separator 100, for example, combustion gas stream 21 and combustion gas stream 23. Fourth product stream 241 may be recovered optionally from second end 205 of a portion of contactor 202 within conditioning zone 240, conditioning zone 240, second-stage adsorptive separator 200 and MSA system 10. Conditioning zone 240, second-stage adsorptive separator 200 and MSA system 10 may be fluidly connected to direct fourth product stream 241 to, for example, a stack (not shown in FIG. 1) for dispersion and release into the ambient environment, to another gas separation process, or to an industrial process (all not shown in FIG. 1).

The exemplary embodiments herein described are not intended to be exhaustive or to limit the scope of the invention to the precise forms disclosed. They are chosen and described to explain the principles of the invention and its application and practical use to allow others skilled in the art to comprehend its teachings.

As will be apparent to those skilled in the art in light of the foregoing disclosure, many alterations and modifications are possible in the practice of this invention without departing from the scope thereof. Accordingly, the scope of the invention is to be construed in accordance with the substance defined by the following claims.

What is claimed is:

1. A multi-stage adsorptive gas separation process for separating at least a first component from a multi-component fluid mixture, said multi-stage adsorptive gas separation process comprising:
a. admitting said multi-component fluid mixture as at least a portion of a feed stream into a first-stage adsorptive gas separator, adsorbing at least a portion of said first component of said feed stream of said first-stage adsorptive gas separator on at least one adsorbent material in a contactor in said first-stage adsorptive gas separator, recovering a first product stream from said first-stage adsorptive gas separator;
b. admitting a first regeneration stream for said first-stage adsorptive gas separator into said first-stage adsorptive gas separator, desorbing at least a portion of said first component adsorbed on said at least one adsorbent material in said contactor in said first-stage adsorptive gas separator, recovering a second product stream from said first-stage adsorptive gas separator enriched in said first component relative to said multi-component fluid mixture;
c. admitting said second product stream from said first-stage adsorptive gas separator as a feed stream into a second-stage adsorptive gas separator, adsorbing at least one of said first component or a second component of said feed stream of said second-stage adsorptive gas separator on at least one adsorbent material in a contactor in said second-stage adsorptive gas separator, recovering a first product stream from said first-stage adsorptive gas separator, and
d. admitting a first regeneration stream for said second-stage adsorptive gas separator into said second-stage adsorptive gas separator, desorbing at least a portion of one of said first component or said second component adsorbed on said at least one adsorbent material in said contactor in said second-stage adsorptive gas separator, recovering a second product stream from said first-stage adsorptive gas separator.

2. The process of claim 1, wherein said first regeneration stream for said first-stage adsorptive gas separator further comprising a first regeneration medium and said first regeneration stream for said second-stage adsorptive gas separator further comprising a third regeneration medium, and said first regeneration medium comprises a different medium from said third regeneration medium.

3. The process of claim 1, wherein during step b, admitting said first regeneration stream into said first-stage adsorptive gas separator results in increasing a temperature of said at least one adsorbent material in said contactor in said first-stage adsorptive gas separator.

4. The process of claim 1, wherein during step d, admitting said first regeneration stream for said second-stage adsorptive gas separator into said second-stage adsorptive gas separator results in increasing a temperature of said at least one adsorbent material in said contactor in said second-stage adsorptive gas separator.

5. The process of any one of claims 1 through 4, further comprising admitting a second regeneration stream for said first-stage adsorptive gas separator into said first-stage adsorptive gas separator, desorbing at least a portion of said first component adsorbed on said at least one adsorbent material in said contactor in said first-stage adsorptive gas separator, recovering a third product stream from said first-stage adsorptive gas separator.

6. The process of any one of claims 1 through 4, further comprising admitting a second regeneration stream for said second-stage adsorptive gas separator into said second-stage adsorptive gas separator, desorbing at least a portion of said first component or said second component adsorbed on said at least one adsorbent material in said contactor in said second-stage adsorptive gas separator, recovering a third product stream from said second-stage adsorptive gas separator.

7. The process of claim 5, wherein said second regeneration stream for said first-stage adsorptive gas separator further comprising a second regeneration medium, said second regeneration medium comprises at least one of air, multi-component fluid mixture and carbon dioxide.

8. The process of claim 6, wherein said second regeneration stream for said second-stage adsorptive gas separator further comprising a second regeneration medium, said second regeneration medium comprises at least one of air, said multi-component fluid mixture andr carbon dioxide.

9. The process of claim 2, wherein said first regeneration medium comprises at least one of air or a multi-component fluid mixture and said third regeneration medium comprises at least one of steam, condensable gas, condensable solvent, and electricity.

10. The process of any one of claims 1, 7, 8 and 9, wherein said multi-component fluid mixture comprises a combustion gas stream.

11. The process of claim 1, wherein said first component comprises at least one of carbon dioxide, and a contaminant.

12. The process of claim 1, wherein said second component comprises at least one of nitrogen and a contaminant.

13. The process of any one of claims 9 and 10, wherein said contaminant comprises one or more of sulfur oxides, nitrogen oxides, particulate matter, and a heavy metal.

14. The process of any one of claims 1 and 5, further comprising admitting a conditioning stream into said first-stage adsorptive gas separator and said contactor in said first-stage adsorptive gas separator; decreasing the temperature of said at least one adsorbent material in said contactor in said first-stage adsorptive gas separator, recovering a fourth product stream from said contactor in said first-stage adsorptive gas separator, and said first-stage adsorptive gas separator.

15. The process of any one of claims 1 and 6, further comprising admitting a conditioning stream into said second-stage adsorptive gas separator and said contactor in said second-stage adsorptive gas separator; decreasing a temperature of said at least one adsorbent material in said contactor in said second-stage adsorptive gas separator, and recovering a fourth product stream from said contactor in said second-stage adsorptive gas separator, and said second-stage adsorptive gas separator.

16. The process of claim 1, further comprising admitting said first regeneration stream for said first-stage adsorptive gas separator into said contactor in said first-stage adsorptive gas separator to flow in a direction counter-flow to a direction of flow of said feed stream in said separator.

17. The process of claim 1, further comprising admitting said first regeneration stream for said second-stage adsorptive gas separator into said contactor in said second-stage adsorptive gas separator to flow in a direction counter-flow to a direction of flow of said feed stream in said separator.

18. The process of claim 6, further comprising admitting said second regeneration stream for said first-stage adsorptive gas separator into said contactor in said first-stage adsorptive gas separator to flow in a direction co-current to a direction of flow of said feed stream in said separator.

19. The process of claim 7, further comprising admitting said second regeneration stream for said first-stage adsorptive gas separator into said contactor in said first-stage adsorptive gas separator to flow in a direction co-current to a direction of flow of said feed stream in said separator.

20. The process of claim 15, further comprising admitting said conditioning stream into said contactor in said first-stage adsorptive gas separator to flow in a direction co-current to a direction of flow of said feed stream in said separator.

21. The process of claim 16, further comprising admitting said conditioning stream into said contactor in said second-stage adsorptive gas separator to flow in a direction co-current to a direction of flow of said feed stream in said separator.

22. The process of claim 1, further comprising prior to step a., admitting at least a portion of said multi-component fluid stream as at least a portion of said feed stream for said first-stage adsorptive gas separator into a hot circuit of a heat exchanger, decreasing a temperature of said at least a portion of the feed stream for said first-stage adsorptive gas separator to equal to or less than a first threshold temperature.

23. The process of claim 1, wherein in step a., admitting said multi-component fluid mixture as at least a portion of said feed stream comprises admitting said multi-component fluid mixture at a temperature equal to or less than a first threshold temperature.

24. The process of any one of claims 1 and 22, further comprising in step a., increasing a temperature of said at least one adsorbent material in said contactor in said first-stage adsorptive gas separator to a second threshold temperature, and in step b., increasing said temperature of said at least one adsorbent material in said contactor in said first-stage adsorptive gas separator to a third threshold temperature, where said third threshold temperature is greater than said second threshold temperature.

25. The process of claim 1, further comprising in step c., increasing a temperature of said at least one adsorbent material in said contactor in said second-stage adsorptive gas separator to a seventh threshold temperature, and in step d., increasing said temperature of said at least one adsorbent material in said contactor in said second-stage adsorptive gas separator to an eighth threshold temperature, where said eighth threshold temperature is greater than said seventh threshold temperature.

26. The process of any one of claims 1, 24 and 25, wherein a change in temperature between said second threshold temperature and said third threshold temperature is equal to or greater that a change in temperature between said seventh threshold temperature and said eighth threshold temperature.

27. The process of claims any one of 22, and 23, wherein said first threshold temperature is 50° C.

28. The process of any one of claims 22, and 23, wherein said first threshold temperature is 40° C.

29. The process of any one of claims 22, and 23, wherein said first threshold temperature is 30° C.

30. A multi-stage adsorptive gas separation system for separating at least a first component from a multi-component fluid stream, the system comprising:
a. a first-stage adsorptive gas separator further comprising at least one adsorbent material in at least one contactor, fluidly connected to a multi-component fluid source to receive at least a portion of said multi-component fluid stream as at least a portion of a feed stream for first-stage adsorptive gas separator, and fluidly connected to said multi-component fluid source to receive at least a portion of said multi-component fluid stream as a first regeneration stream;
b. a second-stage adsorptive gas separator further comprising at least one adsorbent material in at least one contactor, fluidly connected to said first-stage adsorptive separator to receive a second product stream from said first-stage adsorptive separator as a feed stream for said second-stage adsorptive gas separator and fluidly connected to a first regeneration stream source to receive a steam stream as a first regeneration stream.

31. The system of claim 30 further comprising a heat exchanger wherein a hot circuit of said heat exchanger is fluidly connected to said multi-component fluid source to receive said multi-component fluid stream and fluidly connected to admit said multi-component fluid stream into said first-stage adsorptive gas separator.

32. The system of claim 31, further comprising a fan fluidly connected to a cold circuit of said heat exchanger to admit an air stream into said cold circuit of said heat exchanger, and said cold circuit of said heat exchanger is fluidly connected at least one of said first-stage adsorptive gas separator and said second-stage adsorptive gas separator to admit said air stream as a second regeneration stream.

33. The system of claim 32, wherein said fan is fluidly connected to at least one of said first-stage adsorptive gas separator and said second-stage adsorptive gas separator to admit an air stream as a conditioning stream into at least one of said first-stage adsorptive gas separator and said second-stage adsorptive gas separator.

34. The system of claim 30, further comprising a condensing heat exchanger fluidly connected to said second-stage adsorptive gas separator to admit a second product stream from said second-stage adsorptive gas separator into said condensing heat exchanger.

35. The system of claim 30, wherein said first-stage adsorptive gas separator is fluidly connected to admit a third product stream from said first-stage adsorptive gas separator as at least a portion of said feed stream into said first-stage adsorptive gas separator.

36. The system of claim 30, wherein said second-stage adsorptive gas separator is fluidly connected to admit a third product stream from said second-stage adsorptive gas separator as at least a portion of said feed stream into said first-stage adsorptive gas separator.

37. A multi-stage adsorptive gas separation process for separating at least a first component from a multi-component fluid mixture, said multi-stage adsorptive gas separation process comprising:
a. admitting at least a portion of said multi-component fluid mixture at a temperature equal to or less than a first threshold temperature into a first-stage adsorptive gas separator; adsorbing at least a portion of a first component of said multi-component fluid mixture on at least one adsorbent material in a contactor in said first-stage adsorptive gas separator; increasing a temperature of said at least one adsorbent material said contactor in said first-stage adsorptive gas separator to a second threshold temperature; recovering a first product stream from said first-stage adsorptive gas separator depleted in said first component relative to said multi-component fluid mixture;
b. admitting a first regeneration stream for the first-stage adsorptive gas separator into said first-stage adsorptive gas separator, increasing a temperature of said at least one adsorbent material in said contactor in said first-stage adsorptive gas separator to a third threshold temperature; desorbing at least a portion of said first component adsorbed on said at least one adsorbent material in said contactor in said first-stage adsorptive gas separator; recovering a second product stream from said first-stage adsorptive gas separator enriched in said first component relative to said multi-component fluid mixture from said first-stage adsorptive gas separator;
c. admitting a second regeneration stream for the first-stage adsorptive gas separator at a fourth threshold temperature into said first-stage adsorptive gas separator; desorbing at least a portion of said first component adsorbed on said at least one adsorbent material in said contactor in said first-stage adsorptive gas separator; decreasing said temperature of said at least one adsorbent material in said contactor in said first-stage adsorptive gas separator to a fifth threshold temperature; recovering a third product stream enriched in said first component relative to said multi-component fluid mixture from said contactor in said first-stage adsorptive gas separator and said first-stage adsorptive gas separator;
d. admitting a conditioning stream for said first-stage adsorptive gas separator into said first-stage adsorptive gas separator; decreasing said temperature of said at least one adsorbent material in said contactor in said first-stage adsorptive gas separator to a sixth threshold temperature; recovering a fourth product stream from said first-stage adsorptive gas separator;
e. admitting a feed stream into a second-stage adsorptive gas separator; adsorbing at least one of said first component or a second component of said multi-component fluid mixture on said at least one adsorbent material in said contactor in said second-stage adsorptive gas separator; increasing said temperature of said at least one adsorbent material in said contactor in said second-stage adsorptive gas separator to a seventh threshold temperature; recovering a first product stream from said second-stage adsorptive gas separator depleted in at least one of said first component or said second component relative to said multi-component fluid mixture from said second-stage adsorptive gas separator;
f. admitting a first regeneration stream for said second-stage adsorptive gas separator into said second-stage adsorptive gas separator; increasing a temperature of said at least one adsorbent material in said contactor in said second-stage adsorptive gas separator to an eighth threshold temperature; desorbing at least a portion of, one of said first component or said second component on said at least one adsorbent material in said contactor in said second-stage adsorptive gas separator; recovering a second product stream from said second-stage adsorptive gas separator depleted in one of said first component or second component relative to said multi-component fluid mixture from said contactor in said second-stage adsorptive gas separator, and said second-stage adsorptive gas separator;
g. admitting a second regeneration stream for said second-stage adsorptive gas separator at a ninth threshold temperature, into said second-stage adsorptive gas separator; desorbing at least a portion of, one of said first component or said second component adsorbed on said at least one adsorbent material in said contactor in said second-stage adsorptive gas separator; decreasing said temperature of said at least one adsorbent material in said contactor in said second-stage adsorptive gas separator to a tenth threshold temperature; recovering a third product stream enriched in said first component relative to said multi-component fluid mixture from said second-stage adsorptive gas separator, and
h. admitting a conditioning stream for said second-stage adsorptive gas separator into said second-stage adsorptive gas separator; decreasing the temperature of said at least one adsorbent material in said contactor in said second-stage adsorptive gas separator to an eleventh threshold temperature, and recovering a fourth product stream from said second-stage adsorptive gas separator.

38. The process of claim 37, wherein said first threshold temperature is 50° C.

39. The process of claim 37, wherein said first threshold temperature is 40° C.

40. The process of claim 37, wherein said first threshold temperature is 30° C.

41. The process of claim 37, wherein said second threshold temperature is greater than said first threshold temperature.

42. The process of claim 41, wherein said third threshold temperature is greater than said second threshold temperature.

43. The process of claim 42, wherein said fourth threshold temperature is equal to or less than said third threshold temperature and equal to or greater than said second threshold temperature.

44. The process of claim 41, wherein said fifth threshold temperature is equal to or greater than said second threshold temperature.

45. The process of claim 41, wherein said sixth threshold temperature is equal to or less than said second threshold temperature.

46. The process of claim 41, wherein said seventh threshold temperature is greater than said second threshold temperature.

47. The process of claim 46, wherein said eighth threshold temperature is greater than said seventh threshold temperature.

48. The process of claim 47, wherein said ninth threshold temperature is equal to or less than said eighth threshold temperature.

49. The process of claim 48, wherein said tenth threshold temperature is equal to or less than said ninth threshold temperature.

50. The process of claim 49, wherein said eleventh threshold temperature is equal to or less than at least one of said tenth threshold temperature and said sixth threshold temperature.

51. The process of claim 47, wherein a change in temperature between said second threshold temperature and said third threshold temperature is equal to or greater that a change in temperature between said seventh threshold temperature and said eighth threshold temperature.

52. The process of claim 37, wherein in step e., said feed stream comprises at least a portion of said second product stream of said first-stage adsorptive gas separator.

53. The process of claim 37, wherein said first regeneration stream for said first-stage adsorptive gas separator and said first regeneration stream for said second-stage adsorptive gas separator, further comprising different regeneration mediums.

54. The process of claim 37, wherein in step b., said first regeneration stream for said first-stage adsorptive gas separator further comprising said multi-component fluid mixture.

55. The process of claim 37, wherein said second regeneration stream for said first-stage adsorptive gas separator and said second regeneration stream for said second-stage adsorptive gas separator, further comprising same regeneration mediums.
